(19) United States
(12) Patent Application Publication
(10) Pub. No.: US 2010/0247115 A1
(43) Pub. Date: Sep. 30, 2010

(54) APPARATUS FOR MEASURING LENGTH OF RECORDING MATERIAL, IMAGE FORMING APPARATUS, AND PROGRAM

(75) Inventors: Minoru OHSHIMA, Kanagawa (JP); Yoshinari IWAKI, Kanagawa (JP); Kazuyuki TSUKAMOTO, Tokyo (JP); Takao FURUYA, Kanagawa (JP); Kozo TAGAWA, Kanagawa (JP); Takeshi KATO, Kanagawa (JP); Koji MOROFUJI, Tokyo (JP); Toshiyuki KAZAMA, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/547,107

(22) Filed: Aug. 25, 2009

(30) Foreign Application Priority Data
Mar. 25, 2009 (JP) 2009-073160
Mar. 25, 2009 (JP) 2009-073171

(51) Int. Cl. G03G 15/00; G01B 5/02

(52) U.S. Cl. 399/16; 702/163

(57) ABSTRACT

An apparatus for measuring a length of a recording material, includes: a rotating member that rotates while contacting a conveyed recording material; a detecting section that detects a rotation amount of the rotating member; an information obtaining section that obtains at least one of information of an image formed on the recording material and information of the recording material; and a calculating section that calculates a length of the recording material in a direction of the conveyance, based on an output from the detecting section and the information obtained by the information obtaining section.

### CROSS-REFERENCE TO RELATED APPLICATIONS

This application is based on and claims priority under 35 USC 119 from Japanese Patent Application No. 2009-073160 filed on Mar. 25, 2009 and Japanese Patent Application No. 2009-073171 filed on Mar. 25, 2009.

### BACKGROUND

### TECHNICAL FIELD

The present invention relates to an apparatus for measuring the length of a recording material, an image forming apparatus, and a computer readable medium storing a program.

### SUMMARY

According to an aspect of the invention, there is provided an apparatus for measuring a length of a recording material including: a rotating member which rotates while contacting a conveyed recording material; a detecting section which detects a rotation amount of the rotating member; an information obtaining section which obtains information of an image formed on the recording material and/or information of the recording material; and a calculating section which calculates a length of the recording material in a direction of the conveyance, based on an output from the detecting section and the information obtained by the information obtaining section.

### BRIEF DESCRIPTION OF THE DRAWINGS

Exemplary embodiments of the present invention will be described in detail based on the following figures, wherein:

FIG. 1 is a diagram showing an example of an apparatus for measuring the length of a recording material;

FIG. 2 is a diagram showing an example of an image forming apparatus;

FIG. 3 is a block diagram showing the configuration of a control system of the image forming apparatus of FIG. 2;

FIG. 4 is a flowchart showing an example of a length measuring procedure;

FIG. 5 is a diagram showing the principle of the length measurement in an exemplary embodiment;

FIG. 6 is a diagram showing the principle of the length measurement in the exemplary embodiment;

FIGS. 7A and 7B are diagrams showing states where a length measuring roll contacts sheets having different thicknesses;

FIG. 8 is a diagram showing a length measuring apparatus of an exemplary embodiment;

FIGS. 9A and 9B are diagrams showing a length measuring apparatus of an exemplary embodiment;

FIG. 10 is a diagram showing a length measuring apparatus of an exemplary embodiment;

FIG. 11 is a diagram showing an image forming apparatus of an exemplary embodiment; and

FIGS. 12A and 12B are diagrams showing the principle of the length measurement.

### DESCRIPTION OF REFERENCE NUMERALS AND SIGNS

100 . . . length measuring apparatus, 101 . . . length measuring roll, 102 . . . rotation shaft, 103 . . . swing arm, 104 . . . swing shaft, 105 . . . swing arm supporting member, 106 . . . extension arm, 107 . . . coil spring, 108 . . . arm, 110 . . . conveying roll, 111 . . . conveying roll, 112 . . . sheet, 114 . . . lower chute, 115 . . . upper chute, 116 . . . edge sensor, 117 . . . edge sensor, 119 . . . rotary encoder.

### DETAILED DESCRIPTION

### (1) First Exemplary Embodiment

### (Configuration of Apparatus for Measurement)

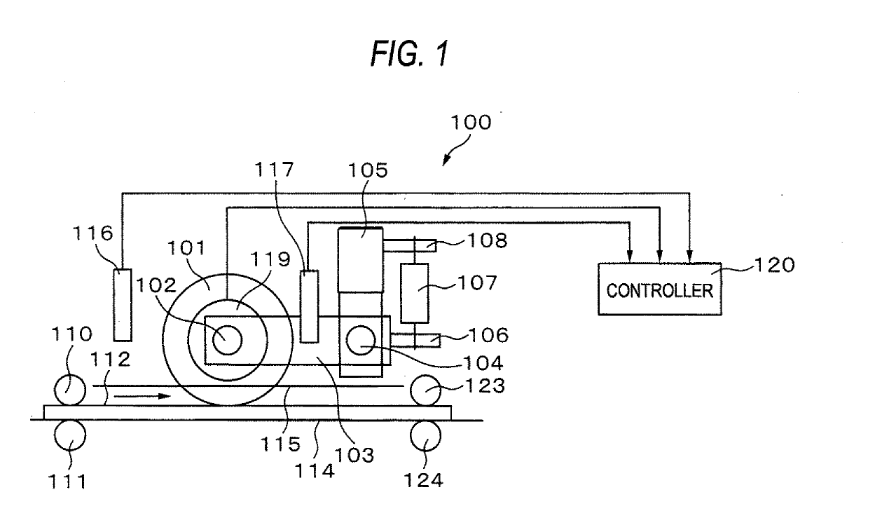

FIG. 1 is a diagram showing an example of an apparatus for measuring the length of a recording material. FIG. 1 shows a length measuring apparatus 100 which is an example of an apparatus for measuring the length of a recording material. The length measuring apparatus 100 includes a length measuring roll 101 which is an example of a measurement rotating member. The length measuring roll 101 has a disk-like shape having a width, and includes a rotation shaft 102.

A rotary encoder 119 which is an example of a section that detects a rotation amount is connected to the rotation shaft 102, and configured so that information (information of the rotation amount and its change) of rotation of the rotation shaft 102 is electrically obtained. The output of the rotary encoder 119 is sent to a controller 120 which will be described later. The rotation shaft 102 is rotatably attached to a swing arm 103. The swing arm 103 is swingably attached to a swing arm supporting member 105 by a swing shaft 104. The swing arm supporting member 105 is fixed to a case (not shown) of the length measuring apparatus 100.

An extension arm 106 extends from a side of the swing arm 103 opposite to the portion to which the length measuring roll 101 is attached. An end of a coil spring 107 is attached to the extension arm. The other end of the coil spring 107 is attached to an arm 108 which extends from the supporting member. The coil spring 107 is in a pulled state, so that a force of causing the swing arm 103 to swing in the counterclockwise direction in the figure is generated.

Conveying rolls 110, 111 are placed on the upstream side (the left side in FIG. 1) of the length measuring roll 101. The conveying rolls 110, 111 nip a sheet 112 to convey the sheet 112 in the rightward direction in the figure. The conveying roll 110 is driven by a motor, and the conveying roll 111 receives a driving force from the conveying roll 110 to be rotated. Conveying rolls 123, 124 are placed on the downstream side of the length measuring roll 101. The conveying rolls 123, 124 nip the sheet 112 to convey the sheet 112 in the rightward direction in the figure. The conveying roll 123 is driven by a motor, and the conveying roll 124 receives a driving force from the conveying roll 123 to be rotated. The front side (the side opposite to the flow) of the flow of the conveyed sheet 112 is called the upstream side, and the side of the flowing direction (conveyance direction) of the sheet 112 is called the downstream side.

The sheet 112 is an example of a recording material (recording sheet) having a sheet-like material, and, for example, is a paper member onto which an image is to be formed. With respect to a material for forming the recording material, in addition to a paper member, for example, a resin-made member which may be employed as an OHP sheet, or a material in which a coating process of forming a resin film is applied to the surface of a paper member may be used.

The reference numeral 114 denotes a lower chute constituting a face with which the sheet is contacted. The lower chute 114 is a member on the face, and the sheet 112 is conveyed in a state where it contacts the chute 114. An upper chute 115 is placed so as to be opposed to the lower chute 114 across a predetermined gap. The upper chute 115 is a planer member which restricts the sheet 112 from the upper side so that the position of the sheet 112 is not upward displaced.

An edge sensor 116 is placed upstream from the length measuring roll 101, and an edge sensor 117 is placed downstream therefrom. The edge sensors 116, 117 are photoelectric sensors each of which is configured by an LED and a photo sensor, and optically detect passages of the front and rear edges of the conveyed sheet 112, respectively.

The outputs of the edge sensors 116, 117 are sent to the controller 120. The controller 120 has a function of a computer, and includes a CPU, a memory, and an interface. The controller has a function of calculating the length of the sheet 112 in the conveyance direction, and that of serving as a controlling device of an image forming apparatus which will be described later. These functions will be described later.

### (Image Forming Apparatus)

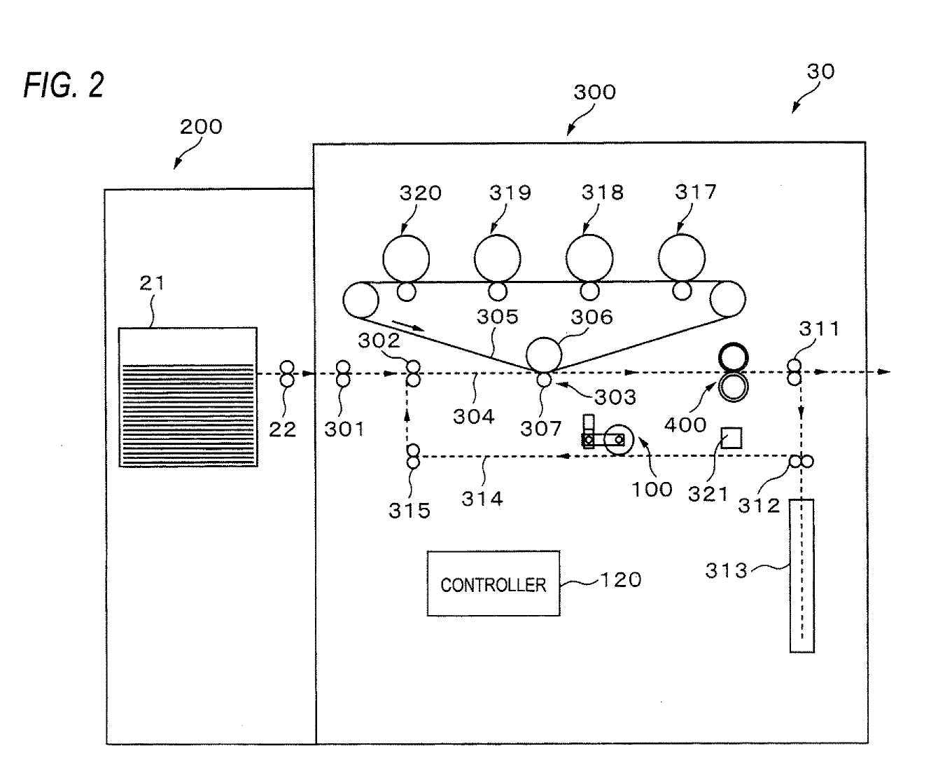

An example of an image forming apparatus to which the Invention is applied will be described. FIG. 2 is a diagram showing an example of an image forming apparatus to which the invention is applied. FIG. 2 shows an image forming apparatus 30. The image forming apparatus 30 includes a sheet supplying unit 20 which supplies a sheet, an image forming unit 300 having an image forming section, and a fixing device 400.

### (Sheet Supplying Unit)

The sheet supplying unit 20 includes: a housing device 21 which houses plural sheets; a feeding mechanism (not shown) which feeds a sheet in the rightward direction in the figure from the housing device 21; and a conveying roll 22 which conveys the sheet fed from the feeding mechanism, in the rightward direction in the figure.

### (Image Forming Unit)

The image forming unit 300 includes a conveying roll 301 which conveys the sheet fed from the sheet supplying unit 20, into the image forming unit 300. On the downstream side of the conveying roll 301, a conveying roll 302 is placed which conveys the sheet fed from the conveying roll 301 or that fed from a conveying roll 315 that will be described later, on a conveying path 304 toward a secondary transferring station 303. The secondary transferring station 303 includes a transferring roll 306 and an opposing roll 307. A transferring belt 305 and the sheet are clamped between the rolls, whereby a toner image on the transferring belt 305 is transferred onto the sheet.

The fixing device 400 having a function of fixing the toner image on the sheet by means of heat and pressure, to the sheet is placed downstream from the secondary transferring station 303. A conveying roll 311 is placed downstream from the fixing device 400. The conveying roll 311 feeds the sheet which is sent from the fixing device 400, to the outside of the apparatus or to a conveying roll 312.

In the case where an image is to be formed on both faces of the sheet, the conveying roll 311 feeds the sheet to the conveying roll 312 at the stage where the image formation on the initial face (first face) is ended. Then, the sheet is sent from the conveying roll 312 to an inverting device 313. The inverting device 313 feed backs the sent sheet toward the conveying roll 312, and the conveying roll 312 sends out the sheet which is discharged from the inverting device 313, to a conveying path 314.

The length measuring apparatus 100 which is exemplarily shown in FIG. 1 is placed in the conveying path 314. The sheet sent out to the conveying path 314 is measured with respect to the length in the conveyance direction by the length measuring apparatus 100, fed from the conveying roll 315 to the conveying roll 302, and then sent out to the conveying path 304. In this case, the sheet is inverted with respect to the case where the sheet is initially conveyed through the conveying path 304. The sheet which is again conveyed through the conveying path 304 is sent to the secondary transferring station 303 to undergo transfer of an image onto the second face (the rear face with respect to the first face).

The primary and secondary transferring processes which are performed on the image to be formed on the second face are controlled on the basis of information of the length of the sheet in the conveyance direction which is measured by the length measuring apparatus 100. This is performed in order to suppress a phenomenon that the position on the second face where the image is to be formed is deviated because of a dimensional change of the sheet caused by an influence of the image formed on the first face.

An image detecting device 321 is placed in the conveying path 304 for inverting the sheet. The image detecting device 321 optically detects the image which is formed on the first face of the sheet 112, and which already undergoes the fixing process, and obtains the density of the image. Detected data are compared with those of a reference image density, so that the image density is obtained as an area coverage value. The area coverage value shows the densities of images of the basic colors. In the case of a color image, three colors of YMC are to be detected, and the maximum value is 300% (100% of each color×3). In the case of a monochrome image, the maximum value of the area coverage value is 100%.

The image forming unit 300 includes primary transferring units 317, 318, 319, 320. Each of the primary transferring units includes a photosensitive drum, a cleaning device, a charging device, an exposing device, a developing device, and a transferring roll. The primary transferring units 317, 318, 319, 320 superimposingly transfer toner images of Y (yellow), M (magenta), C (cyan), and B (black) onto the transferring belt 305 which is rotated. As a result, the color toner images in which the toner images of YMCK are superimposed is formed on the transferring belt 305.

The operations of the components which are described above are controlled by the controller 120. The controller 120 performs also a process relating to the measurement of the length of the sheet. In the process of forming an image on the second face in the case where the image formation is performed on the both faces of the sheet, the controller 120 controls the image forming process on the basis of the measured sheet length. Data which are obtained by correcting sheet length data which are obtained from the output of the length measuring apparatus 100, on the basis of information relating to the material of the sheet, and that of the image density of the image formed on the first face are used as the sheet length in the control. The contents of the correcting process will be described later.

In the configuration shown in FIG. 2, the length measuring apparatus 100 may be disposed upstream from the secondary transferring station 303 in the conveying path 304, the length of the sheet in the conveyance direction may be measured irrespective of the front or rear face of the sheet at the stage where an image has not been formed, and the information may be used in the image information.

### (Configuration of Control System)

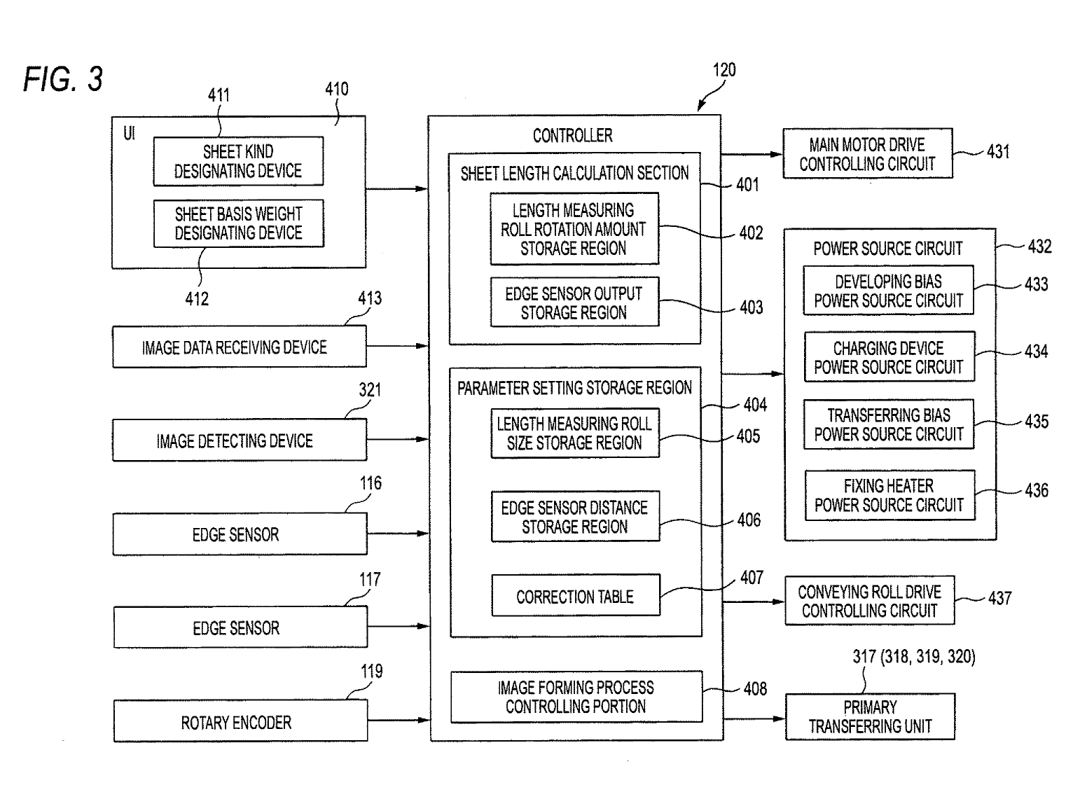

An example of the configuration of a control system of the image forming apparatus 30 which is exemplified in FIG. 2 will be described. FIG. 3 is a block diagram showing an example of the configuration of the control system of the image forming apparatus 30. FIG. 3 illustrates the controller 120 shown in FIGS. 1 and 2.

The controller 120 is a unit which functions as a computer, and has a software function which will be described below, in addition to functions of a usual computer, such as a timer function. Programs for performing the following function and operations which will be described later are stored in a memory which is disposed in the controller 120, and which is not shown.

The controller 120 includes a sheet length calculating section 401. The sheet length calculating section 401 has a calculating function of calculating the sheet length, and includes a length measuring roll rotation amount storage region 402 and edge sensor output storage region 403 which are memory regions required for the calculation. The length measuring roll rotation amount storage region 402 stores data relating to the rotation amount of the length measuring roll 101. The edge sensor output storage region 403 stores information of the outputs of the edge sensors 116, 117.

The controller 120 includes a parameter setting storage region 404. The parameter setting storage region 404 stores set values of parameters which are necessary in the calculation in the sheet length calculating section 401. The parameter setting storage region 404 includes a length measuring roll size storage region 405, an edge sensor distance storage region 406, and a correction table 407. The length measuring roll size storage region 405 stores data relating to the circumferential length of the length measuring roll. The edge sensor distance storage region 406 stores data of the distance between the edge sensors 11C, 117. The correction table 407 includes a data table which defines relationships between parameters which are previously checked, and which are required in calculation. The contents of the correction table 407 will be described in relation to the below description of operations.

The controller 120 includes an image forming process controlling portion 408. The image forming process controlling portion 408 generally controls processes relating to the image formation. Devices which perform processes relating to the image formation include a main motor drive controlling circuit 431, a power source circuit 432, a conveying roll drive controlling circuit 437, and the primary transferring units 317 to 320. These devices which perform processes relating to the image formation will be described later.

A UI (user interface) 410 is connected to the controller 120. The UI (user interface) 410 is disposed in the image forming apparatus 30 of FIG. 2 (not illustrated in FIG. 2). The UI (user interface) 410 has a touch screen display mechanism so that the user can input various kinds of information and perform various settings. In this example, the UI (user interface) 410 includes a sheet kind designating device 411 and a sheet basis weight designating device 412 (although the UI includes other UI functions, their description is omitted).

The sheet kind designating device 411 receives an input of information relating to the sheet kind designated by the user. Examples of information relating to the sheet kind are the basis weight of the sheet, the thickness of the sheet (including not only a specific thickness, but also information such as “thick sheet” and “thin sheet”), the material of the sheet (information distinguishing the material of the sheet such as plain paper, a coated sheet, or an OHP sheet), and the designation of the sheet (such as a model number in the case where the kind of the sheet to be used is designated).

The sheet basis weight designating device 412 receives an input of the basis weight (g/m²) of the sheet by the user. The input of the basis weight may be performed by an input of a specific value, or by, for example, defining section A of from m₁ g/m² to m₂ g/m², section B of from m₂ g/m² to m₃ g/m², section C of from m₃ g/m² to m₄ g/m², . . . , and inputting information of one of the sections by the user (or designating the section).

The above-described data obtained from the UI (user interface) 410 are used in the process (described later) of correcting the sheet length. The UI (user interface) 410 may function on the side of a terminal which sends image data to the image forming apparatus 30.

Image data are supplied from an image data receiving device 413 to the controller 120. The image data receiving device 413 functions as an inputting portion which receives image data of an image to be formed. The image data are sent to the image forming apparatus 30 through a communication line (such as a LAN) which is not shown. Also data which are sent from the image detecting device 321 shown in FIG. 2, and which relate to the image density are supplied to the controller 120. The data relating to the image density are used in the sheet length correcting process which will be described later.

Furthermore, signals from the edge sensors 116, 117 shown in FIG. 1 are supplied to the controller 120. The signals are used in performing the sheet length correcting process which will be described later. A pulse count signal from the rotary encoder 119 shown in FIG. 1 is supplied to the controller 120. The pulse count signal is used in performing the sheet length correcting process which will be described later.

The devices in which the operation is controlled by the image forming process controlling portion 408, and which perform processes relating to the image formation will be described. The devices include the main motor drive controlling circuit 431, the power source circuit 432, the conveying roll drive controlling circuit 437, and the primary transferring units 317 to 320.

The main motor drive controlling circuit 431 is a driving circuit which drives a motor generating a driving force for rotating the transferring belt 305 of FIG. 2. The power source circuit 432 includes a developing bias power source circuit 433, a charging device power source circuit 434, a transferring bias power source circuit 435, and a fixing heater power source circuit 436. The developing bias power source circuit 433 generates a bias voltage to be applied in the process in which the toner is supplied from the developing device to the photosensitive drum in each of the primary transferring units 317 to 320 of FIG. 2. The charging device power source circuit 434 is a power source circuit for the charging devices which charge the photosensitive drums in the primary transferring units 317 to 320.

The transferring bias power source circuit 435 generates a bias voltage to be applied in the primary transfer in which the toner image is transferred to the transferring belt 305 in each of the primary transferring units 317 to 320, and also a bias voltage which is applied in the secondary transferring station 303. The fixing heater power source circuit 436 is a power source for a heater disposed in the fixing device 400. The conveying roll drive controlling circuit 437 is a driving circuit which drives a motor for operating rolls of a conveying mechanism for conveying the sheet, such as the conveying roll 302.

### (Operation Example)

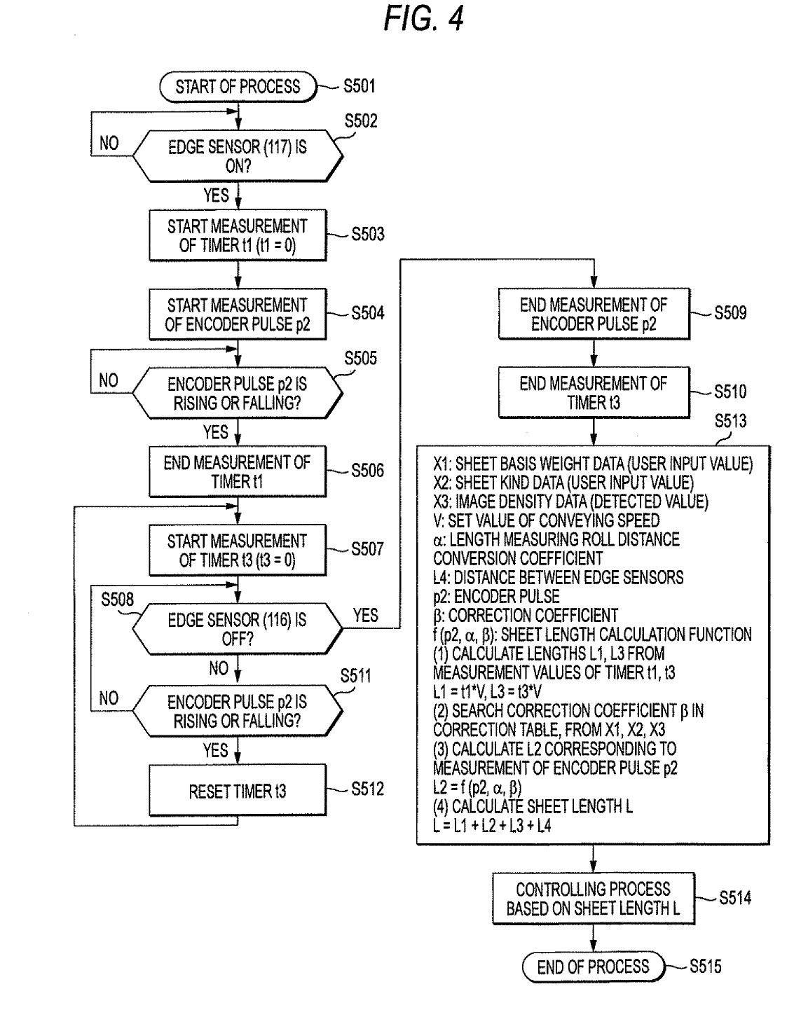

Hereinafter, an example of the operation of the control system shown in FIG. 3 will be described. FIG. 4 is a flowchart showing an example of the operation. An example of the process which, in the image formation on the both faces of the sheet, is performed in the image formation on the second sheet will be described. An operation program defining the procedure of the operation shown in FIG. 4 is stored in the memory disposed in the controller 120, and read out to an appropriate storage region (RAM region) to be executed.

In the case where the image formation is to be performed on the both faces of the sheet, after the image formation is performed on the first face, the sheet is switched back by the inverting device 313 of FIG. 2, and then sent into the conveying path 314. At this timing, a process shown in FIG. 4 is started.

When the process shown in FIG. 4 is started (step S501), it is determined whether the edge sensor 117 is ON or not (step S502). If the edge sensor 117 is ON, the process proceeds to step S503, and, if not, the process of step S502 is repeated. The state where the edge sensor is ON means a state where the sheet exists in the portion of the edge sensor and the edge sensor senses the sheet.

In step S503, the measurement of a timer t1 is started from t1=0. At the same time as the start of the measurement of the timer t1, an encoder pulse p2 supplied from the rotary encoder 119 is started to be measured (step S504). When the encoder pulse p2 which the secondary transferring station 303 is in a pulse rising portion or a pulse falling portion, the determination of step S505 is YES, and the measurement of the timer t1 is ended (step S506). At this timer the count value of the timer t1 is obtained as a measurement parameter t1.

Then, the measurement of a timer t3 is started from t3=0 (step S507), and it is determined whether the edge sensor 116 is OFF or not, or namely whether the sheet has passed over the front edge sensor or not (step S508). If the edge sensor 116 is OFF, the measurement of the encoder pulse p2 is ended (step S509), and the measurement of the timer t3 is ended (step S510). At this time, the count value of the timer t3 is obtained as a measurement parameter t3.

By contrast, if the edge sensor 116 is not OFF in step S508, it is determined whether the encoder pulse p2 is in the pulse rising portion or the pulse falling portion (S511). If the pulse is in one of the portions, the timer t3 is reset (S512), the process returns to step S507 to restart the measurement of the timer t3. If the pulse is not in the portions, step S508 is repeated.

According to the process, after the measurement of the timer t3 is started, if the edge sensor 116 is OFF at the stage where the edge of the initial pulse waveform has not been output, the step S509 and the subsequent processes are performed. If the edge sensor 116 is not OFF at the stage where the edge of the initial pulse waveform has not been output, and the edge (rising or falling) of the initial pulse waveform is output, the timer t3 is reset, and step S507 and the subsequent processes are again performed.

After step S510, step S513 is performed. In step S513, first, L1 and L3 are calculated by using the measured values t1, t3 of the timers t1, t3. This calculation is performed because of the following reason.

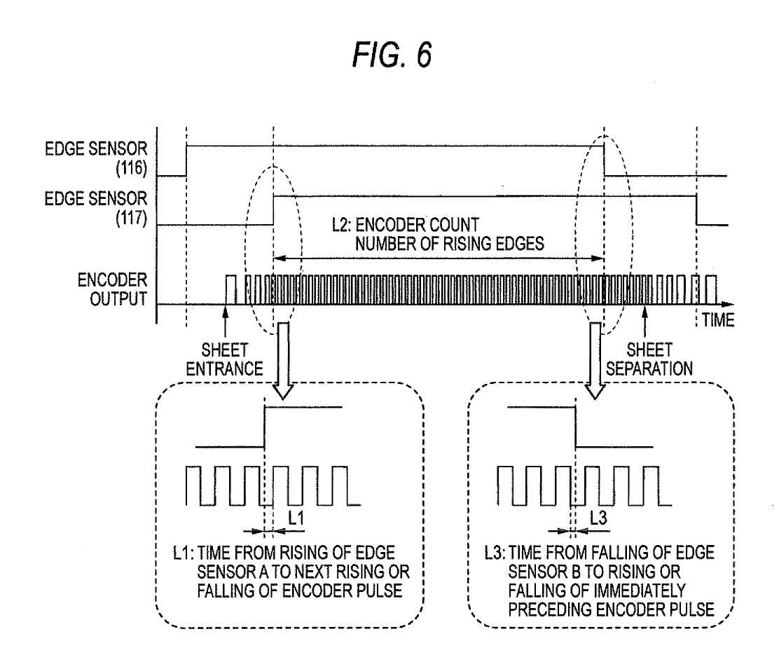

FIG. 6 is a diagram showing changes of the output waveforms of the edge sensors and the rotary encoder 119. In FIG. 6, a change of the output waveform of the rotary encoder 119 is exaggeratingly shown. As shown in FIG. 6, in one initial pulse which is output from the rotary encoder 119 immediately after the sheet 112 enters the length measuring roll 101, and one last pulse which is output from the rotary encoder 119 immediately before the sheet 112 separates from the length measuring roll 101, a measurement accuracy which is smaller than the pulse interval (in other words, the resolution of the rotary encoder) cannot be expected. Even after the contact of the sheet 112 is ended, the length measuring roll 101 is rotated by inertia. From only rotation information of the rotary encoder, therefore, it is impossible to identify the timing when the sheet 112 separates from the length measuring roll 101.

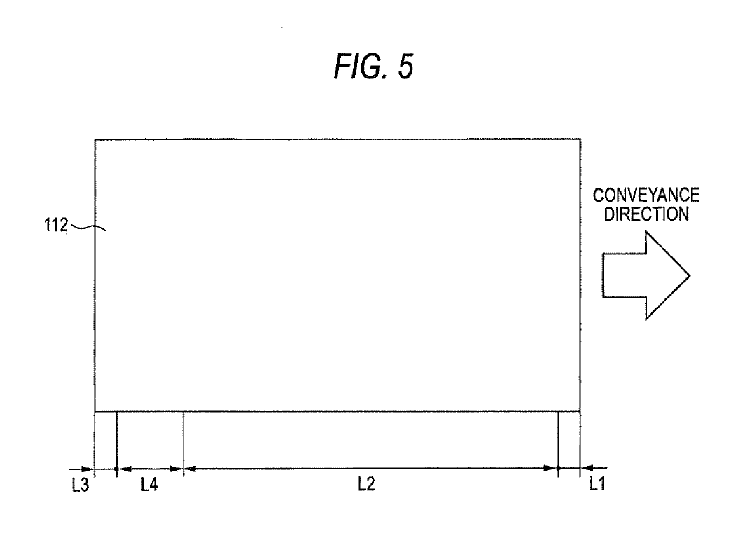

In this example, therefore, L1 and L3 are calculated by using t1 and t3. FIG. 5 is a diagram showing the positions of L1 and L3 in an easily understood manner. In FIG. 5, also L2 and L4 which will be described later are shown.

After L1 and L3 are calculated, a correction coefficient β is searched in the correction table 407 (see FIG. 3) on the basis of X1, X2, and X3. In this example, the case where the sheet basis weight designating device 412 is operated by the user and the value of the basis weight of the sheet is manually input will be described. Examples of data tables which are used in this case, and which are stored in the correction table 407 are shown in Tables 1 and 2 below. The data tables are produced on the basis of values which are previously obtained by experiment.

TABLE 1

| Image density | Basis weight | β: correction coefficient |
|---|---|---|
| σ₁ | m₁ | β₁₁ |
| σ₁ | m₂ | β₁₂ |
| σ₁ | m₃ | β₁₃ |
| σ₁ | • | • |
| σ₁ | • | • |
| σ₁ | • | • |

TABLE 2

| Image density | Basis weight | β: correction coefficient |
|---|---|---|
| σ₂ | m₁ | β₂₁ |
| σ₂ | m₂ | β₂₂ |
| σ₂ | m₃ | β₂₃ |
| σ₂ | • | • |
| σ₂ | • | • |
| σ₂ | • | • |

Table 1 shows relationships between the sheet basis weight and the correction coefficient β with respect to a certain defined image density σ₁. Table 2 shows relationships between the sheet basis weight and the correction coefficient β with respect to an image density σ₂ which is different from σ₁. In the above, the data tables of σ₁ and σ₂ are shown as examples. However, similar data tables are prepared in the number by which a required accuracy is obtained.

In this example, the image density (σ value) of an image which is already formed on the first face is detected by the image detecting device 321 of FIG. 3. On the basis of the image density (σ value), search is performed on the data table which is exemplified in Table 1 or 2. On the other hand, X1 is input by the user, and the basis weight m of the used sheet is known. Therefore, the corresponding value of β is searched in the searched data table. By using the value of β, a sheet correction function f(p2, α, β) is calculated.

The sheet correction function f(p2, α, β) is a function which finds the length measured by the length measuring roll 101 on the basis of the output pulse (the encoder pulse p2) of the rotary encoder 119, and the value of the coefficient β that corrects an influence of the measurement error due to the sheet basis weight and the image density of the image which is already formed. When the function is used, the sheet length calculation in which the influence of the measurement error due to the sheet basis weight and the image density of the image which is already formed is corrected is performed. The length measuring roll distance conversion coefficient α which is used in step S513 is a coefficient relating to the circumferential length of the length measuring roll 101 that is stored in the length measuring roll size storage region 405 of FIG. 3. As the sheet correction function f(p2, α, β), a function which is previously obtained by experiment is used.

In this way, L2=f(p2, α, β) is calculated, and L2 is obtained. Then, L=L1+L2+L3+L4 is calculated by using the distance L4 between the edge sensors 116, 117, and the length L of the sheet 112 is obtained. The contents of the process of step S513 are as described above.

Next, the image formation on the second face of the sheet is controlled on the basis of the sheet length L obtained in step S513 (step S514). The control is performed by the image forming process controlling portion 408 of FIG. 3. When the image formation on the second face of the sheet is ended, the process is ended (step S515).

### (Function 1)

First, the function of measuring the sheet length in the image formation on the second face of the sheet will be described. In the case where an image is to be formed on both the faces of the sheet, the dimensions of the sheet are changed as a result of the image formation on the first face. In order to correctly make the image formation positions on the front and rear faces coincide with each other, therefore, a process in which the dimensions of the sheet are measured after the image formation on the first face, and the measured values are reflected in the image formation on the second face is effective.

### (Function 2)

Next, the function of, in the measurement of the sheet length, correcting the measured values based on the basis weight of the sheet and the image density of the image formed on the first face will be described. The difference in sheet basis weight affects mainly that in sheet thickness. It is experimentally known that, when sheets have different thicknesses, the errors of measured values of the lengths of the sheets are different from each other. This seems to be caused by the phenomenon that, although very small, the penetration degree of the length measuring roll into the sheet, and the position of the rotation shaft of the length measuring roll are changed, and the changes affect the measured values based on rotation of the length measuring roll. In order to correct an influence due to the error, correction coefficients corresponding to sheet basis weights such as shown in Table 1 or 2 are previously obtained, and the measured values are corrected by using the correction coefficient. As a result, an error of a measured value of the sheet length due to the difference in basis weight is suppressed from being generated.

Furthermore, it is experimentally known that, when an image is formed on the first face, errors of measured values of the sheet length are different depending on the density of the formed image. This seems to be caused by the phenomenon that the surface state of the sheet is changed by the influence of the fixed toner materials constituting the image, and, for example, the penetration degree during contact with the length measuring roll, and the friction state with the length measuring roll are changed. It seems that the change causes an error to occur in the measurement using the length measuring roll. Therefore, correction coefficients corresponding to image densities such as shown in Table 1 or 2 are previously obtained, and the measured values are corrected by using the correction coefficient. As a result, an error of a measured value of the sheet length due to the difference in image density is suppressed from being generated.

### (Modifications)

In the above-described example, the image formed on the sheet is optically detected, thereby obtaining the image density. As another example, a method may be employed in which an image process is performed in a software manner on electronic data of an image that are received by the image data receiving device 413 of FIG. 3, and then the image density of the image formed on the sheet is obtained. In this case, the image density is not detected from an image which is actually formed, and hence image density information of a portion in which detection by the image detecting device 321 cannot be performed can be obtained. Furthermore, information of the image density distribution in the sheet can be obtained more easily.

In the above-described example, correction in which both influences respectively due to the basis weight of the sheet and the image density of the image formed on the first face are considered is applied to the measured values obtained by using the rotary encoder. Alternatively, only the sheet basis weight or the image density may be used as the correction parameter. In the alternative, a fixed value is employed as the other item.

The sheet basis weight may be obtained by a sensor. In this case, the sheet thickness is detected by a thickness detection sensor, and the sheet basis weight is obtained on the basis of the detection result. The thickness detection sensor may have a configuration where a movable member contacts a sheet, and the thickness of the sheet is obtained from the displacement of the movable member.

In the above, the example in which the basis weight is used as the parameter relating to the kind of the sheet has been described. The difference in material (such as the difference between paper and a resin sheet, and that between a plain sheet and a coated sheet) may be reflected in the correction coefficient β.

The program for executing the procedure of the process shown in FIG. 4 may be stored in an appropriate recording medium, and then provided therefrom.

Furthermore, a preferred configuration of the invention for reducing a measurement error of a recording material will be described.

### (State of Swing Arm 103)

The thickness of the sheet 112 which can be measured by the length measuring apparatus 100 shown in FIG. 1 is set to 50 to 300 μm. Therefore, the intermediate value of the thickness is 175 μm. In this example, when a sheet having a thickness of 175 μm is to be measured, the extension direction of the swing arm 103 and the conveying surface (the lower chute 114) for the sheet are set so as to be parallel to each other.

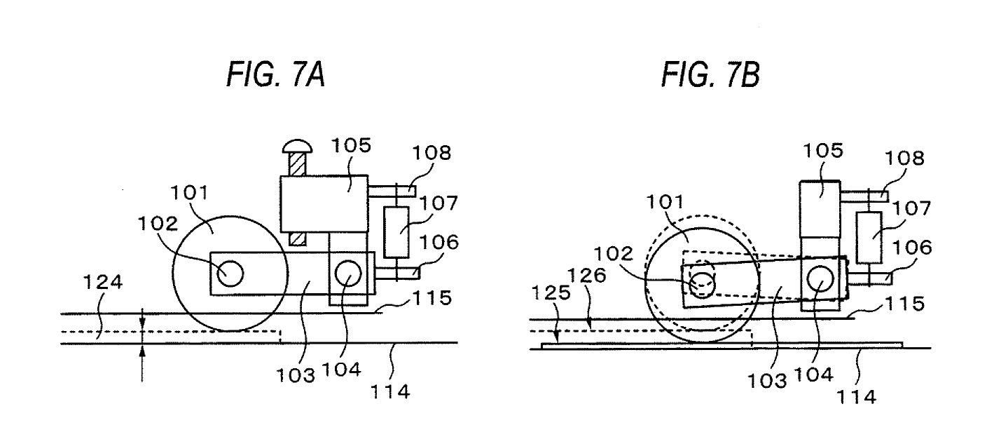

FIG. 7A shows a state where a sheet 124 to be measured has a thickness of 175 μm (the intermediate value).

In FIG. 7B, the case where the sheet has the minimum thickness is indicated by the solid line denoted by the reference numeral 125, and that where the sheet has the maximum thickness is indicated by the broken line denoted by the reference numeral 126. According to this setting, in an assumed case where the conveying surface is horizontal, when the sheet has the maximum thickness (300 μm), the position of the rotation shaft 102 is higher than that of the swing shaft 104, and, when the sheet has the minimum thickness (50 μm), the position of the rotation shaft 102 is lower than that of the swing shaft 104. When the sheet has a thickness of the intermediate value (175 μm), the position of the rotation shaft 102 is coincident with that of the swing shaft 104.

The range of the thickness of the sheet 112 which can be measured by the length measuring apparatus 100 is restricted by that of the thickness of a sheet that can be used in an apparatus or system (for example, an image forming apparatus or image forming system) in which the length measuring apparatus 100 is placed. Even in a case where the range of the thickness of a sheet which can be used in the length measuring apparatus 100 is 50 to 300 μm, when the usable range in an apparatus or system in which the length measuring apparatus 100 is placed is 100 to 250 μm, the predetermined sheet thickness range which can be measured by the length measuring apparatus 100 is 100 to 250 μm.

### (Measuring Method 1)

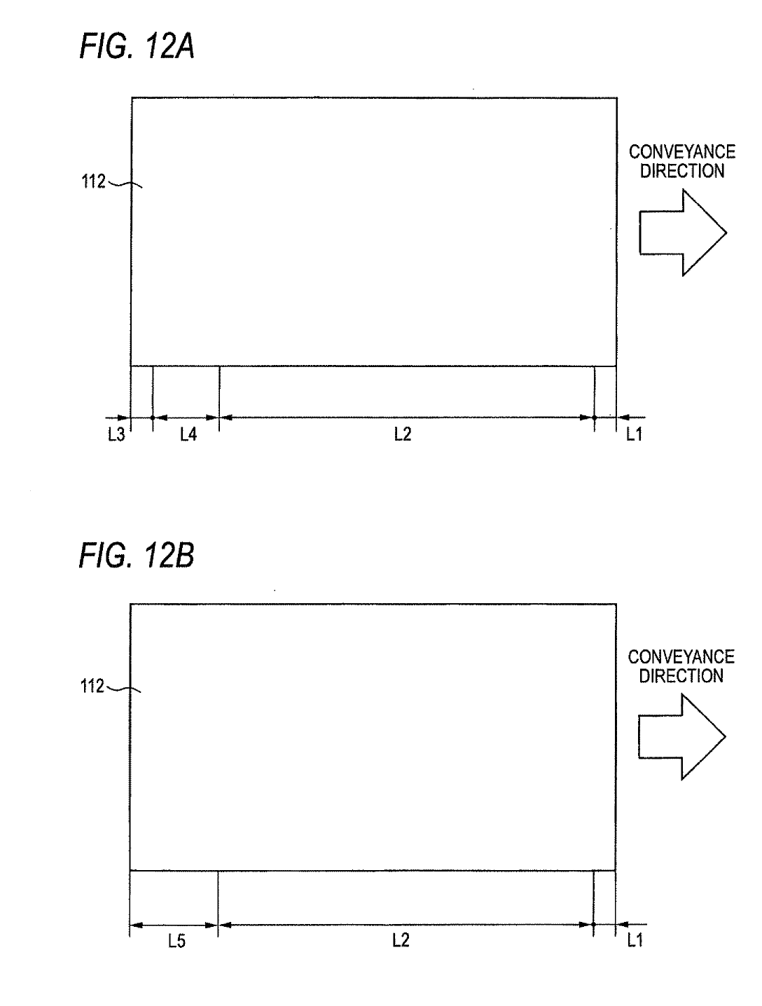

FIGS. 12A and 12B are diagrams relating two kinds of measuring methods. The method shown in FIG. 12A is identical with that shown in FIG. 4, and hence its description is omitted.

### (Measuring Method 2)

In the method shown in FIG. 12B, only the edge sensor 117 is used. First, L1 is calculated by using the output of the edge sensor 117. Furthermore, a time T3 is estimated which is obtained by backward counting from the time when the edge sensor 117 is turned OFF, and during which the length measuring roll 101 is estimated to be rotated while being surely followed by the movement of the sheet 112. The counting is started from a pulse which is first output after the time when the edge sensor 117 is turned ON, and continued until the pulse immediately before the time T3 is output, thereby calculating L2.

From the time when the edge sensor 117 is turned OFF, and an estimated speed, a time T4 when the sheet 112 separates from the length measuring roll 101 is estimated. By using an estimated speed V3 of the sheet 112 at the time T4, L5=V3×(T4−T3) is calculated. Finally, L1+L2+L5 is calculated, thereby obtaining the value of the length of the sheet 112.

As the inclination of the swing arm 103 with respect to the conveyance direction (conveying surface) is larger, an error of measurement based on the rotation amount of the length measuring roll 101 is more increased. Therefore, it is important to reduce the inclination of the swing arm 103 with respect to the conveyance direction and due to the thickness difference of the sheet, as small as possible.

In the configuration shown in FIG. 1, it is set so that, when a sheet having the intermediate value of the range of measurable thicknesses is to be measured, the extension direction of the swing arm 103 is parallel to the conveying surface. According to the configuration, in the case of the minimum sheet thickness (the solid line of the reference numeral 125), As shown in FIG. 7B, the inclination of the swing arm 103 with respect to the conveying surface (in this example, the horizontal direction) is formed as an angle of depression, and, in the case of the maximum sheet thickness (the broken line of the reference numeral 126), the inclination of the swing arm 103 with respect to the conveying surface is formed as an angle of elevation. The absolute values of the angles of depression and elevation are equal to each other. In this case, the swing range with respect to the horizontal direction is minimum.

This is apparent from the phenomenon that, when the thickness of the sheet which causes the swing arm 103 to be parallel to the conveying surface for the sheet is deviated from the intermediate value, the inclination of the swing arm 103 with respect to the conveying surface in the case of one of the minimum and maximum thicknesses is increased.

When the inclination of the swing arm 103 with respect to the sheet conveyance direction is suppressed, an error of measurement of the sheet length in the sheet conveyance direction due to the vertical movement of the rotation shaft 102 is suppressed. When the configuration of the exemplary embodiment is employed, therefore, an error of measurement of the sheet length in the conveyance direction is suppressed. The superior property that an error of measurement of the sheet length in the conveyance direction is suppressed is particularly effective in the case where warpage or undulation occurs in the sheet.

### (Modifications)

An opposing roll may be placed in place of the lower chute 114 at the position opposed to the length measuring roll 101 across the sheet 112. The opposing roll may be configured so as to be drivingly rotatable, or to be drivenly rotatable. When an opposing roll is used, however, there is a possibility that the pressure contact force between the roll and the length measuring roll 101 becomes unstable and an error is produced in the measurement result. Therefore, it is preferable that a non-rotatable member such as the lower chute 114 is placed at the position opposed to the length measuring roll 101. In the above, it is set so that, when a sheet having the intermediate value of the range of thicknesses which can be measured by the length measuring apparatus 100 is to be measured, the extension direction of the swing arm 103 is parallel to the conveying surface. Alternatively, in the case where the kind of the sheet 112 which is frequently used in the length measuring apparatus 100 is previously known, it is set so that, when the sheet is to be measured, the extension direction of the swing arm 103 is parallel to the conveying surface.

### (2) Second Exemplary Embodiment

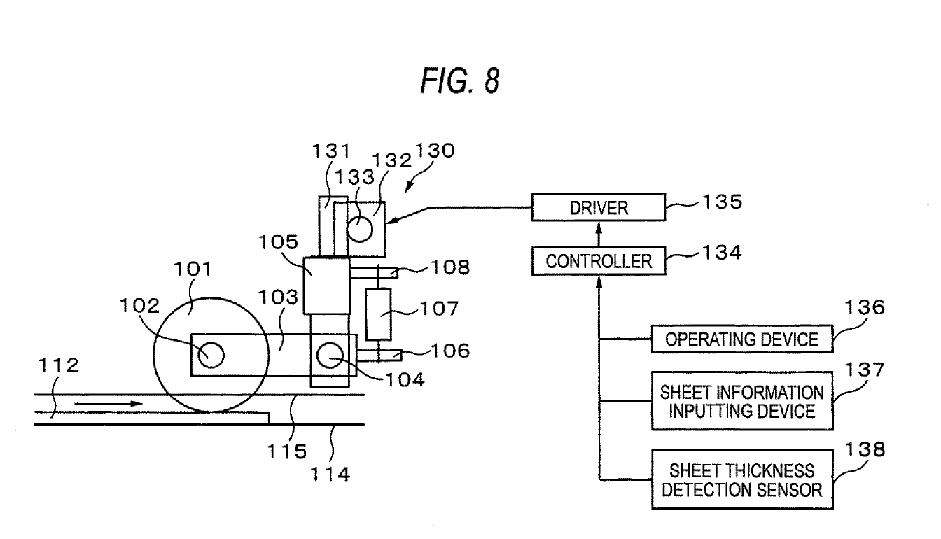

FIG. 8 is a diagram showing a length measuring apparatus of an exemplary embodiment which is different from that of FIG. 1. FIG. 8 shows a length measuring apparatus 130. The length measuring apparatus 130 includes the same components as those of the length measuring apparatus 100 of FIG. 1. In the following description, components which are configured differently from those of the length measuring apparatus 100 of FIG. 1 will be described. The scheme for measuring the length of a sheet is identical with that of the first exemplary embodiment.

In the length measuring apparatus 130 of FIG. 8, the swing arm supporting member 105 is not fixed to the case (not shown) of the length measuring apparatus 130, and structured so that the arm can be moved by a motor with respect to the case in the vertical direction in the figure. In the length measuring apparatus 130, namely, a movable member 131 in which a rack (not shown) is formed is fixed to an upper portion the swing arm supporting member 105. The rack of the movable member 131 meshes with a pinion 133 fixed to a driving shaft of a motor 132. When the motor 132 rotates, the movable member 131 meshing with the pinion 133 is vertically moved, and, in accordance with this, the swing arm supporting member 105 is vertically moved, so that the position of the swing shaft 104 is vertically moved.

The motor 132 is driven by a driver 135 which is operated by a control signal from a controller 134. Output signals from an operating device 136, a sheet information inputting device 137, and a sheet thickness detection sensor 138 are input to the controller 134. On the basis of the input signals, the controller 134 supplies a control signal for controlling the operation of the motor 132.

The operating device 136 is a device for performing an operation of adjusting the height position of the swing shaft 104. When the operating device 136 is operated, the rotation of the motor 132 is controlled, and the position of the swing shaft 104 is adjusted. In the above, the example in which the position of the swing shaft 104 is determined by the motor has been described. Alternatively, a dial or the like may be manually rotated by a mechanical mechanism, and the position of the swing shaft 104 may be adjusted by using the driving force.

The sheet information inputting device 137 is a device (for example, a touch screen display) through which data of the thickness of a sheet to be measured, and data relating to the kind of the sheet are input. When the thickness of the sheet is input into the sheet information inputting device 137, for example, the rotation of the motor 132 is controlled so that the swing shaft 104 is positioned at a level suitable to the thickness. The position suitable to the thickness is a position where the line connecting the swing shaft 104 to the rotation shaft 102 is parallel to the conveying surface for the sheet 112.

The control is performed in the following manner. First, the positional relationship between the sheet thickness and the swing shaft 104 is previously obtained, and its data are stored into the memory in the controller 134. When the sheet information inputting device 137 is operated, then, the data are referred, and the position suitable to the thickness is searched. Based on the result of the search, the control signal from the controller 134 is supplied to the driver 135. As a result, the motor 132 rotates, and the swing shaft 104 is moved to the position suitable to the thickness. When the data relating to the kind of a sheet are input, the table data which are stored in the memory, and which define relationships between sheet kinds and sheet thicknesses is referred, and the data of the sheet thickness are obtained.

The sheet information inputting device 137 has a selection switch which selects one of the functions of the operating device 136, the sheet information inputting device 137, and the sheet thickness detection sensor 138. When the selection switch is operated, a selected one of the operating device 136, the sheet information inputting device 137, and the sheet thickness detection sensor 138 is activated.

The sheet thickness detection sensor 138 detects the thickness of the sheet 112. The sheet thickness detection sensor 138 measures the displacement of a contact arm which contacts the sheet, to physically detect the thickness of the sheet. Although not illustrated, the sheet thickness detection sensor 138 is disposed upstream from the length measuring apparatus 130.

In the case where the function of the sheet thickness detection sensor 138 is activated, the thickness of the sheet 112 is detected on the upstream side of the length measuring apparatus 130, and its information is sent to the controller 134. Based on the detected thickness of the sheet 112, the controller 134 sends the control signal to the driver 135 so that the swing arm 103 is parallel (in this case, horizontal) to the conveying surface of the sheet 112 in the state where the length measuring roll 101 contacts the sheet 112 (the state shown in FIG. 8). On the basis of on the control signal, the driver 135 controls the motor 132.

### (Superior Property of Second Exemplary Embodiment)

The adjustment in which the inclination of the swing arm 103 with respect to the conveying surface of the sheet is minimized in accordance with the thickness of the sheet 112. Therefore, a measurement error of the sheet length due to the difference in thickness of the sheet 112 is suppressed. Furthermore, a measurement error of the sheet length due to warpage or undulation of a sheet is suppressed.

### (Modification of Second Exemplary Embodiment)

Also a configuration may be possible which, in the configuration shown in FIG. 8, includes one of the operating device 136, the sheet information inputting device 137, and the sheet thickness detection sensor 138.

### (3) Third Exemplary Embodiment

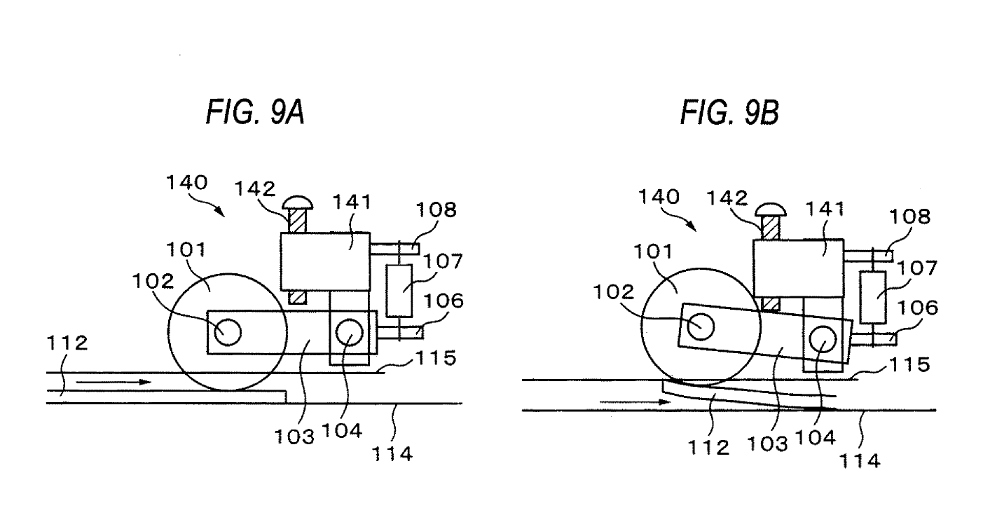

FIGS. 9A and 9B are diagrams showing a length measuring apparatus of an exemplary embodiment which is different from that of FIG. 1. FIG. 9A shows the case where warpage does not occur in the sheet 112, and FIG. 9B shows the case where warpage occurs in the sheet 112. FIGS. 9A and 9B show a length measuring apparatus 140. The length measuring apparatus 140 includes the same components as those of the length measuring apparatus 100 of FIG. 1. In the following description, components which are configured differently from those of the length measuring apparatus 100 of FIG. 1 will be described. The scheme for measuring the length of a sheet is identical with that of the first exemplary embodiment.

In the length measuring apparatus 140 of FIGS. 9A and 9B, a restricting member 142 which restricts the movable range of the swing arm 103 is attached to a swing arm supporting member 141 which supports the swing shaft 104 of the swing arm supporting member 105 in a swingable manner.

In this example, the restricting member 142 is a screw. The restricting member 142 is screwed into a screw hole formed in the swing arm supporting member 141. When the restricting member 142 is rotated, the dimension of the restricting member 142 which is protruded from the swing arm supporting member 141 toward the swing arm 103 is changed.

As shown in FIG. 9B, when the portion of the swing arm 103 corresponding to the rotation shaft 102 is raised because of the warpage of the sheet 112, the swing arm 103 contacts the restricting member 142, and restricted so as not to be further displaced.

In this example, as shown in FIG. 9B, the dimension of the downward protrusion of the restricting member 142 toward the lower side of the swing arm supporting member 141 is made equal to the size by which the length measuring roll 101 is protruded from the upper chute 115. According to the configuration, even when warpage or undulation occurs in the sheet 112, the contact with the sheet 112 is ensured, and it is possible to prevent a situation where a measurement failure is caused, from occurring.

### (Modification)

The configuration shown in FIG. 8 and that shown in FIGS. 9A and 9B may be combined with each other. In this case, a section which restricts the swing range of the swing arm 103 is disposed in addition to the mechanism for vertically moving the swing shaft 104.

### (4) Fourth Exemplary Embodiment

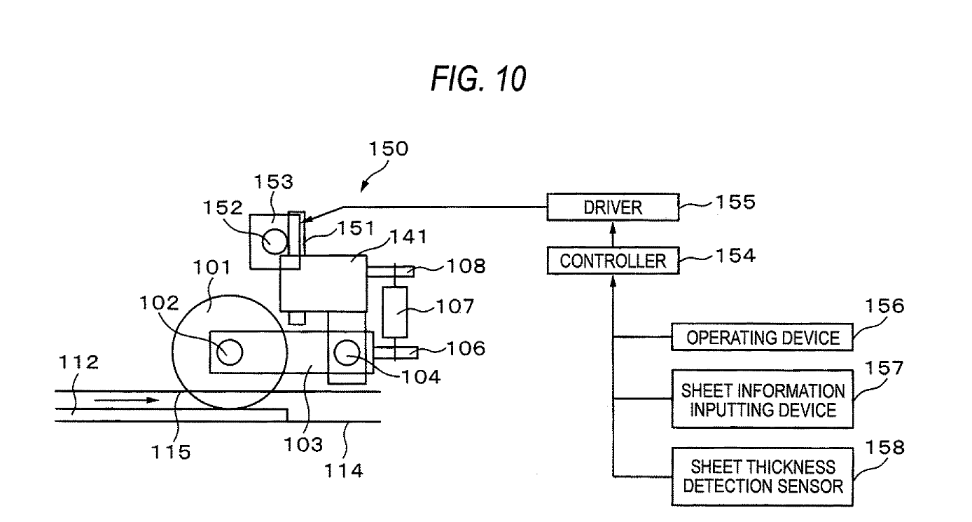

FIG. 10 is a diagram showing a length measuring apparatus in which the configuration of FIGS. 9A and 9B is partly modified. FIG. 10 shows a length measuring apparatus 150. The length measuring apparatus 150 includes the same components as those of the length measuring apparatus 100 of FIG. 1 and the length measuring apparatus 140 of FIGS. 9A and 9B. In the following description, components which are configured differently from those of the length measuring apparatus 100 of FIG. 1 and the length measuring apparatus 140 of FIGS. 9A and 9B will be described. The scheme for measuring the length of a sheet is identical with that of the first exemplary embodiment.

In the length measuring apparatus 150 of FIG. 10, a restricting member 151 which can be vertical moved by a motor 153 is attached to the swing arm supporting member 141. When the restricting member 151 is vertical moved, the member exerts the same function as the restricting member 142 of FIGS. 9A and 9B. In this example, the restricting member 151 is not a screw, and has a rack structure, and a pinion 152 meshes with the rack structure. The pinion 152 is driven by the motor 153 so as to be rotated.

The motor 153 is driven and operated by a driver 155 which is operated by the control signal supplied from a controller 154. On the basis of one of the following three kinds of information, the controller 154 controls the rotation of the motor 153 so that the dimension of the downward protrusion of the restricting member 151 toward the lower side of the swing arm supporting member 141 is made equal to the size by which the length measuring roll 101 is protruded from the upper chute 115.

The first information which can be referred by the controller 154 is information from an operating device 156. To the operating device 156, an operation of adjusting the protruding dimension of the restricting member 151 toward the lower side of the swing arm supporting member 141 is performed. When the operating device 156 is operated, the rotation of the motor 153 is controlled, and the restricting member 151 is vertically moved.

The second information which can be referred by the controller 154 is information from a sheet information inputting device 157. The sheet information inputting device 157 is a device (for example, a touch screen display) through which data of the thickness of the sheet to be measured, and data relating to the kind of a sheet are input. When the thickness of the sheet is input into the sheet information inputting device 157, for example, the rotation of the motor 153 is controlled so that the restricting member 151 is positioned at a height position suitable to the thickness.

The control is performed in the following manner. First, the positional relationship between the sheet thickness and an adequate position (a position where the length measuring roll 101 is protruded from the upper chute 115) of the restricting member 151 is previously obtained, and its data are stored into the memory in the controller 154. When the sheet information inputting device 157 is operated, then, the data are referred, and the height position of the restricting member 151 suitable to the thickness is searched. Based on the result of the search, the control signal from the controller 154 is supplied to the driver 155. As a result, the motor 152 rotates, and the restricting member 151 is moved to the height position suitable to the thickness.

The sheet information inputting device 157 has a selection switch which selects one of the functions of the operating device 156, the sheet information inputting device 157, and the sheet thickness detection sensor 158. When the selection switch is operated, a selected one of the operating device 156, the sheet information inputting device 157, and the sheet thickness detection sensor 158 is activated.

The third information which can be referred by the controller 154 is information from the sheet thickness detection sensor 158. The sheet thickness detection sensor 158 detects the thickness of the sheet 112. The sheet thickness detection sensor 158 measures the displacement of a contact arm which contacts the sheet, to physically detect the thickness of the sheet. Although not illustrated, the sheet thickness detection sensor 158 is disposed upstream from the length measuring apparatus 150.

In the case where the function of the sheet thickness detection sensor 158 is activated, the thickness of the sheet 112 is detected on the upstream side of the length measuring apparatus 150, and its information is sent to the controller 154. Based on the detected thickness of the sheet 112, the controller 154 sends the control signal for adjusting the vertical position of the restricting member 151, to the driver 155 so that the motor 153 rotates. As a result, the vertical position of the restricting member 151 is adjusted so as to attain the state where the length measuring roll 101 is protruded from the upper chute 115.

### (5) Fifth Exemplary Embodiment

### (Image Forming Apparatus)

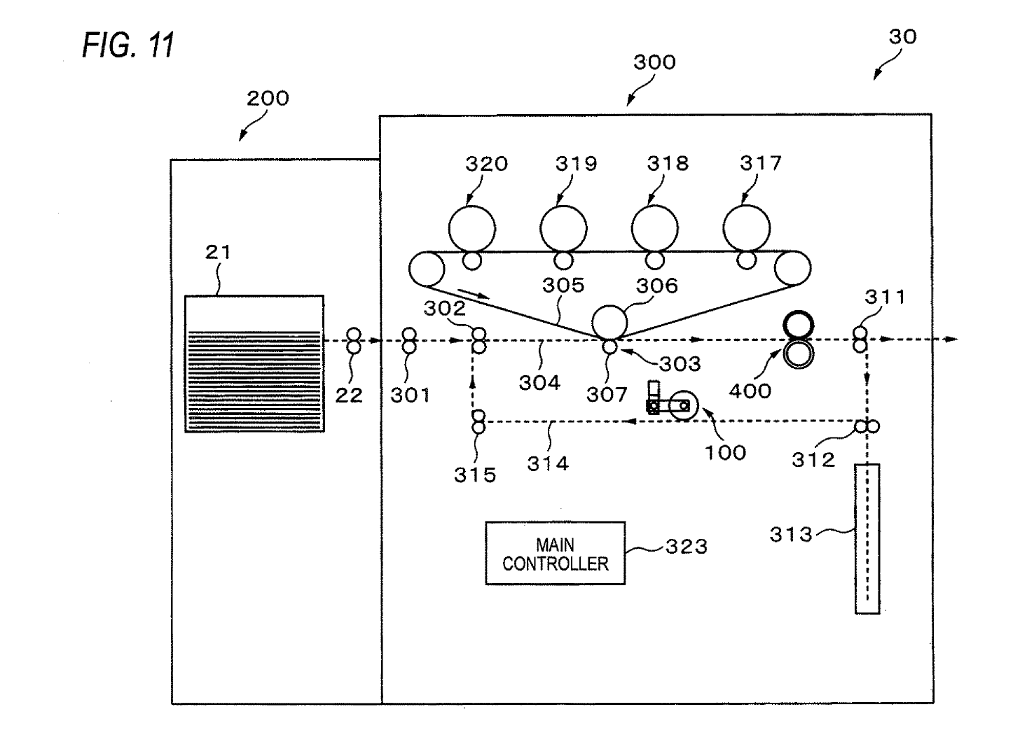

An example of an image forming apparatus to which the invention is applied will be described. FIG. 11 is a diagram showing an image forming apparatus to which the invention is applied is applied. FIG. 11 shows an image forming apparatus 30. The image forming apparatus 30 includes a sheet supplying unit 20 which supplies a sheet, an image forming unit 300 which is an example of an image forming section, and a fixing device 400.

### (Sheet Supplying Unit)

The sheet supplying unit 20 includes: a housing device 21 which houses plural sheets; a feeding mechanism (not shown) which feeds a sheet in the rightward direction in the figure from the housing device 21; and a conveying roll 22 which conveys the sheet fed from the feeding mechanism, in the rightward direction in the figure.

### (Image Forming Unit)

The image forming unit 300 includes a conveying roll 301 which conveys the sheet fed from the sheet supplying unit 20, into the image forming unit 300. On the downstream side of the conveying roll 301, a conveying roll 302 is placed which conveys the sheet fed from the conveying roll 301 or that fed from a conveying roll 315 that will be described later, on a conveying path 304 toward a secondary transferring station 303. The secondary transferring station 303 includes a transferring roll 306 and an opposing roll 307. A transferring belt 305 and the sheet are clamped between the rolls, whereby a toner image on the transferring belt 305 is transferred onto the sheet.

The fixing device 400 having a function of fixing the toner image on the sheet by means of heat and pressure, to the sheet is placed downstream from the secondary transferring station 303. A conveying roll 311 is placed downstream from the fixing device 400. The conveying roll 311 feeds the sheet which is sent from the fixing device 400, to the outside of the apparatus or to a conveying roll 312.

In the case where an image is to be formed on both faces of the sheet, the conveying roll 311 feeds the sheet to the conveying roll 312 at the stage where the image formation on the initial face (first face) is ended. Then, the sheet is sent from the conveying roll 312 to an inverting device 313. The inverting device 313 feed backs the sent sheet toward the conveying roll 312, and the conveying roll 312 sends out the sheet which is discharged from the inverting device 313, to a conveying path 314.

The length measuring apparatus 100 which is exemplarily shown in FIG. 1 is placed in the conveying path 314. The sheet sent out to the conveying path 314 is measured with respect to the length in the conveyance direction by the length measuring apparatus 100, fed from the conveying roll 315 to the conveying roll 302, and then sent out to the conveying path 304. In this case, the sheet is inverted with respect to the case where the sheet is initially conveyed through the conveying path 304. The sheet which is again conveyed through the conveying path 304 is sent to the secondary transferring station 303 to undergo transfer of an image onto the second face.

The primary and secondary transferring processes which are performed on the image to be formed on the second face are controlled on the basis of information of the length of the sheet in the conveyance direction which is measured by the length measuring apparatus 100. This is performed in order to suppress a deviation of the position on the second face where the image is to be formed, caused by a dimensional change of the sheet due to an influence of the image formed on the first face.

The image forming unit 300 includes primary transferring units 317, 318, 319, 320. Each of the primary transferring units includes a photosensitive drum, a cleaning device, a charging device, an exposing device, a developing device, and a transferring roll. The primary transferring units 317, 318, 319, 320 superimposingly transfer toner images of Y (yellow), M (magenta), C (cyan), and B (black) onto the transferring belt 305 which is rotated. As a result, the color toner images in which the toner images of YMCK are superimposed is formed on the transferring belt 305.

The operations of the components which are described above are controlled by a main controller 323. The main controller 321 receives sheet length data output from the length measuring apparatus 100. In the process of forming an image on the second face in the case where the image formation is performed on the both faces of the sheet, the main controller 323 controls the image forming process in which a change of the sheet length is considered, on the basis of the sheet length data obtained from the length measuring apparatus 100. The length measuring apparatus 100 may not be disposed in the conveying path 314, and may be disposed upstream therefrom. For example, the length measuring apparatus may be disposed in rear of the fixing device 400. The illustrated length measuring apparatus 100 has the configuration where a rotation shaft 102 is disposed upstream from a swing shaft 104. Alternatively, the apparatus may have a configuration where the rotation shaft 102 is disposed downstream from the swing shaft 104.

### (Others)

The used length measuring apparatus is not restricted to the length measuring apparatus 100 of FIG. 1, and may be the length measuring apparatus 130 of FIG. 8, the length measuring apparatus 140 of FIG. 9, or the length measuring apparatus 150 of FIG. 10. A configuration may be employed where the position of the length measuring apparatus is upstream from the secondary transferring station 303 in the conveying path 304, the length of the sheet in the conveyance direction is measured irrespective of the front or rear face of the sheet at the stage where an image has not been formed, and the information is used in the image information.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. An apparatus for measuring a length of a recording material, comprising:
a rotating member that rotates while contacting a conveyed recording material;
a detecting section that detects a rotation amount of the rotating member;
an information obtaining section that obtains at least one of information of an image formed on the recording material and information of the recording material; and
a calculating section that calculates a length of the recording material in a direction of the conveyance, based on an output from the detecting section and the information obtained by the information obtaining section.

2. The apparatus for measuring a length of a recording material according to claim 1, wherein the rotating member is brought into contact with the recording material after the image formed on the recording material is fixed.

3. The apparatus for measuring a length of a recording material according to claim 1, wherein detecting sections that detect passage of an edge portion of the recording material are disposed on upstream and downstream sides from the rotating member in the conveyance direction, respectively.

4. The apparatus for measuring a length of a recording material according to claim 1, wherein the image information is information of an image density of the image formed on the recording material.

5. The apparatus for measuring a length of a recording material according to claim 1, wherein the image information is information of an image density of the image, obtained from electronic information on which the image formed on the recording material is based.

6. The apparatus for measuring a length of a recording material according to claim 1, wherein the information of the recording material is previously stored.

7. A computer readable medium storing a program causing a computer to execute a process for calculating, the process comprising:
a detecting step of detecting a rotation amount of a rotating member that rotates while contacting a conveyed recording material;
an information obtaining step of obtaining at least one of information of an image formed on the recording material and information of the recording material; and
a calculating step of calculating a length of the recording material in a direction of the conveyance, based on the rotation amount of the rotating member, detected in the detecting step, and the information obtained in the information obtaining step.

8. The apparatus for measuring a length of a recording material according to claim 1, which further comprises a supporting member that rotatably supports a rotating member in a state where the rotating member is swingable about a swing shaft, and,
in a state where the rotating member contacts the recording material, a line connecting a rotation shaft of the rotating member to the swing shaft is parallel to a conveying surface on which the recording material is conveyed.

9. The apparatus for measuring a length of a recording material according to claim 8, wherein
a range of a thickness of a recording material that is capable of contacting the rotating member and conveyed is predetermined, and,
in a state where the rotating member contacts a recording material having an intermediate value of the thickness range, the line connecting the rotation shaft to the swing shaft is parallel to the conveying surface on which the recording material is conveyed.

10. The apparatus for measuring a length of a recording material according to claim 8, which further comprises an adjusting section that adjusts a distance between the conveying surface on which the recording material is conveyed, and the swing shaft.

11. The apparatus for measuring a length of a recording material according to claim 10, which further comprises:
a receiving section that receives an input of information relating to the thickness of the recording material; and
a controlling section that controls the adjustment in the adjusting section, based on the information received by the receiving section.

12. The apparatus for measuring a length of a recording material according to claim 10, which further comprises:
a thickness detecting section that detects a thickness of the recording material; and
a controlling section that controls the adjustment in the adjusting section, based on an output of the thickness detecting section.

13. The apparatus for measuring a length of a recording material according to claim 8, which further comprises:
a recording material restricting member that is placed on a side of the rotating member with respect to the recording material, and that restricts a movement of the recording material; and
a swing range restricting member that restricts a swing range of the rotating member so that the rotating member is protruded from the recording material restricting member toward the recording material.

14. The apparatus for measuring a length of a recording material according to claim 13, which further comprises a swing range adjusting section that adjusts the swing range.

15. The apparatus for measuring a length of a recording material according to claim 14, which further comprises:
a receiving section that receives an input of information relating to the thickness of the recording material; and
a controlling section that controls the adjustment of the swing range in the swing range adjusting section, based on the information received by the receiving section.

16. The apparatus for measuring a length of a recording material according to claim 14, which further comprises:
a thickness detecting section that detects a thickness of the recording material; and
a controlling section that controls the adjustment of the swing range in the swing range adjusting section, based on an output of the thickness detecting section.

17. The apparatus for measuring a length of a recording material according to claim 8, which further comprises an opposing member that is placed at a position where the opposing member cooperates with the rotating member to nip the recording material, and that is opposed to the rotating member, the opposing member being a non-rotatable member which is not rotated in accordance with the conveyance of the recording material.

18. The apparatus for measuring a length of a recording material according to claim 8, which further comprises a plurality of conveyance rotating members that are arranged in a width direction of the recording material, and that convey the recording material, and the rotating member is positioned between the plurality of conveyance rotating members, in the width direction of the recording material.

19. The apparatus for measuring a length of a recording material according to claim 8, which further comprises:
an opposing member that is placed at a position where the opposing member cooperates with the rotating member to nip the recording material, and that is opposed to the rotating member; and
first and second conveyance rotating members that are placed upstream and downstream from the rotating member, respectively, and that convey the recording material, and
a position where the first conveyance rotating member contacts the conveyed recording material, a position where the second conveyance rotating member contacts the conveyed recording material, and a position where the opposing member contacts the conveyed recording material are placed in a same plane.

20. An image forming apparatus comprising:
the apparatus for measuring a length of a recording material according to claim 1; and
an image forming section that forms an image on the recording material,
the apparatus for measuring a length of a recording material measures the length of the recording material in which an image is formed on a first face by the image forming section,
the image forming section has a controlling section which controls conditions for forming an image, and
the controlling section controls conditions for forming an image on a second face, based on the length measured by the apparatus for measuring the length of a recording material.
